(19) United States
(12) Patent Application Publication
(10) Pub. No.: US 2003/0102836 A1
(43) Pub. Date: Jun. 5, 2003

(54) Safety garage door retrofit system

(76) Inventor: Steve McCall, Chicago, IL (US)

Correspondence Address: David M. Mundt, Cook, Alex, McFarron, Manzo, Cummings & Mehler, Suite 2850, 200 West Adams Street, Chicago, IL, 60606, US

(21) Appl. No.: 10/273,675

(22) Filed: Oct. 18, 2002

Related U.S. Application Data
(63) Continuation-in-part of application No. 09/652,558, filed on Aug. 31, 2000, now Pat. No. 6,469,464.

(51) Int. Cl. H02P 3/00

(52) U.S. Cl. 318/445

(57) ABSTRACT

An automatic door operating safety system particularly used with garage doors is provided. A security timer for a powered overhead garage door causes the door to close after it has been opened for a predetermined time interval. Before timeout, the system will determine by its various sensors whether there is any activity within the area. Upon the absence of such activity the system signals the command for door closures

### CROSS-REFERENCE TO RELATED APPLICATION

This application is a continuation-in-part of U.S. Ser. No. 09/652,558, filed Aug. 31, 2000.

### BACKGROUND OF THE INVENTION

The present invention relates generally to a garage door operator and, in particular, to an automatic garage door closer having a safety sensor for determining whether there is any activity within the garage, particularly a running vehicle, and further having, upon the absence of such activity, a programmable and pre-determined timer and command for the closing of the door.

Remote controlled door operators have become the staple use in residences, parking areas and other locations to which controlled access is deemed essential or desirable. Typically, the remote door operator includes, in addition to the mechanical components of the door and the door mounting system, a motor which is capable of driving the door between an open and a closed position, and a motor controller adapted to be connected to a power supply and which is operatively associated with the motor for controlling the movements of the door in response to various signals. In addition, the typical door operator system comprises a low power, limited range radio transmitter having a pushbutton which is actuable to produce a coded signal, and a radio receiver/ decoder for triggering operation of the controller when the coded signal is received in the proper format. This “remote” avoids the need for the driver to get out of the car to open and close the door in the case of a garage and the like. In addition to the transmitter, such a system also includes a manual wall switch to control the movement of the door.

Although the majority of the problems associated with such a door operating system occur with the remote operator, any damage done, or other essential safety issues, are typically associated with the movement of the door. For example, when a door operator is commanded to close, the door operator may close onto an obstacle in the way of the door which causes damage to the operator. More importantly, the door operator also may close on an object which may be damaged such as an automobile, child's bicycle or even (most particularly), upon a person or child.

With more instances of injury, more laws with regard thereto have been proliferated by the local, state and federal legislate. For example, effective as of Jan. 1, 1993, a law was placed into effect that all electronic garage doors installed must be equipped with a safety device that will reverse a closing door if an obstruction is present in the last six inches of the door's travel, or six inches above ground level. In order to comply with this law, among others, automatic garage door operator manufacturers have incorporated many different safety features. The two such features most incorporated include edge sensors and light beam sensors.

Edge type sensors usually comprise a flexible strip attached to the bottom edge of the garage door, which flexible strip deforms when it comes in contact with an obstacle. Deformation of the flexible strip may increase pressure of a trapped fluid within the strip or close switches signaling the garage door operator that an obstacle has been encountered. The garage door operator then switches into its up mode and immediately raises the garage door. Edge sensors thus provide an open-circuit when no obstruction is sensed and provide an closed-circuit when an obstruction contacts the sensor. This type of sensor is not entirely adequate not only because of its relatively high cost, but more importantly, because once a force was exerted in the opposite direction, a sufficient pressure may have already been exerted against the object to cause damage. For example, if a small child were in the path of the garage door, the child could be knocked down and injured prior to the garage door reversing direction.

On the other hand, light sensors typically include infrared transmitters and receivers hard wired to the motor so that if an obstacle is located between the transmitter and receiver, which necessarily means in the path of the garage door, the receiver would send a signal to a motor controller to reverse direction of the garage door. In other words, the transmitter produces a light beam that is aligned so that it extends across the doorway and strikes the receiver on the other side. As long as the receiver detects the light beam, the receiver outputs a low level signal. When the light beam is broken and the receiver does not detect the presence of the light beam, the sensor outputs a high-level signal indicating the presence of an obstruction in the doorway.

Although these two features may provide for the safety of objects in the path of the garage door, they cannot determine whether there is any activity within the garage, particularly a running vehicle, at the time of door closing. Such a feature is needed when the garage door operating system includes an automatic closer such as that disclosed within U.S. Pat. No. 4,463,292, incorporated herein by reference. Such a system typically includes a security timer for door closure after a predetermined period of time. This automatic closing feature solves the problem of the occasional left open door, or a door that has been opened by stray radio frequency signals. Without the automatic closure, an open door will provide access for intruders to the garage and make it easier for a burglar to break into a door leading from the garage to the house.

However, with this automatic closure comes additional safety problems. Animals, including family pets, people and even small children may get trapped in the garage after the automatic closure. If trapped therein, they may be subjected to extreme heat or extreme cold, trapped gases or even exhaust fumes from a running automobile. The present invention provides for safety features that will determine whether there is any activity in the garage, particularly a running vehicle, before the automatic closure of the door. If desired, the present invention may be combined with the previously discussed edge and/or light sensors to provide for the safest garage door operating system as possible.

Accordingly, it is a general object of the present invention to provide for an improved garage door operator.

It is another general object of the present invention to provide for an automatic garage door closer system.

It is a more specific object of the present invention to provide for a garage door operator having an automatic garage door closer including a safety sensor for determining whether any activity is present within the garage.

Still another more specific object of the present invention is to provide for a garage door operator having an automatic garage door closer including a safety sensor for determining whether an automobile is running within the garage.

### SUMMARY OF THE INVENTION

According to the present invention, there is provided a retrofit automatic garage door closer to be used with existing door operators. A control unit is connected to the motor and is capable of commanding the motor to open and close. Once the door is opened, a programmable timing routine controls the actuation of the motor to close the door upon time out. The timing routine may be effected by one or more activity detectors within the garage.

### BRIEF DESCRIPTION OF THE DRAWINGS

The features of the present invention which are believed to be novel are set forth with particularity in the appended claims. The invention, together with the further objects and advantages therefore, may best be understood by reference to the following description taken in conjunction with the accompanying drawings, in the several figures of which like reference numerals identify like elements, and in which:

FIG. 1 is a perspective view of a garage door operator designed in accordance with the principles of the present invention mounted within a garage and coupled to a garage door to open and close it.

FIG. 2 is a general block diagram of the electronics of the present invention.

FIG. 3 is a general circuit diagram of the preferred embodiment of the auto closure module of FIG. 2.

FIG. 4 is a perspective view of the component parts of an alternate preferred embodiment designed in accordance with the principles of the present invention.

FIG. 5 is a perspective view of the garage door retrofit system of FIG. 4 mounted within a garage and coupled to a garage door opener.

FIG. 6 is a general block diagram of the alternate embodiment of the garage safety system of FIG. 4.

FIG. 7 is a sequence block diagram of the logic of the garage safety system of FIG. 4.

FIG. 8 is a general circuit diagram of the preferred embodiment of the garage safety system of FIG. 4.

### DESCRIPTION OF THE PREFERRED EMBODIMENT

The present invention describes the operation and design of an automatic safety door closer. This design may be that of a completely new system, or one which can retrofit an existing system. In operation, the unit will: 1) detect that the door is open 2) allow the door to remain open for a pre-determined period of time, 3) determine by its various sensors that there is no vehicle activity in the area, 4) warn of imminent door closure, and 5) close the door by command to the associated door opener.

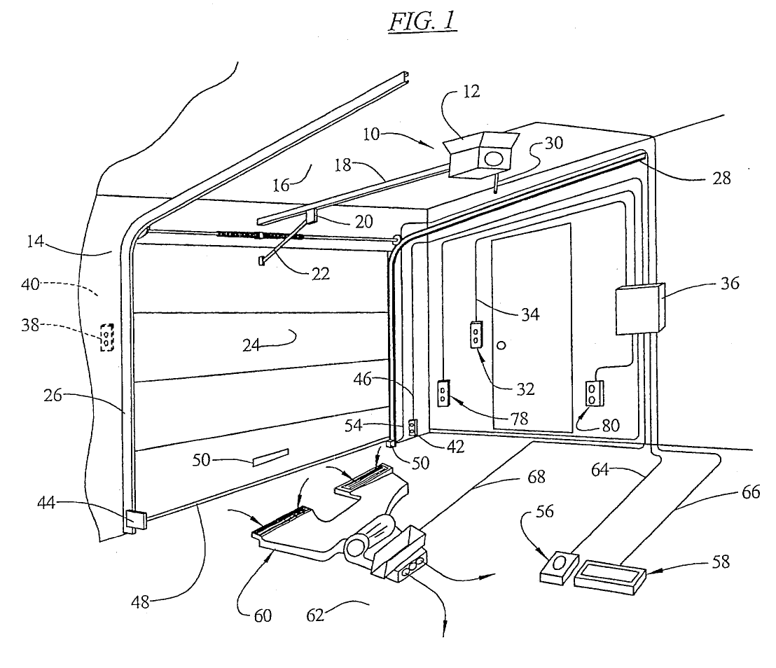

Referring now to the drawings and in particular to FIG. 1, a garage door operator embodying an embodiment of the present invention is generally shown therein and identified by numeral 10. The garage door operator includes a control or head unit 12 mounted within a garage 14 on a ceiling 16. A transmission including a T-rail or screw drive 18 extends from the control head 12 and has a disconnectable trolley 20 connected thereto. An arm 22 is connected to the trolley and is connected to a multi-panel garage door 24 for opening and closing thereof. The garage door is carried on a pair of L-shaped channels 26 and 28 as is conventional for multi-panel garage doors. A radio transmitter or “remote” (not shown) may communicate by radio frequency energy with an antenna 30 extending from the head unit 12 to cause the head unit to open and close the garage door. Likewise, an inside control panel 32 may communicate over a wire 34 to the head unit 12 through the auto closure circuit module 36. A permanently mounted keypad radio transmitter 38 may also be mounted on the outside wall 40 of the garage and communicate with antenna 30 of the head unit to command the head unit to open and close the door. Light sensors, in the form of a combination photo-emitter and detector 42 and cooperating infrared reflector 44, may be utilized to detect obstacles in the path of the door's travel. The detector 42 is connected by leads 46 to the head unit (through module 36) to receive electrical energy therefrom, while the reflector 44 is positioned at the opposite door edge to receive and reflect back infrared energy to the detector 42.

The above description is of a typical garage door operating system. The present invention, however, has been designed for a garage door system having an automatic door closer. Such a system may generally include a limit switch for either indicating that the door is opening or is already fully opened. A separate unit containing a limit switch with suitable brackets for mounting may be provided to detect that the door is open. For example, such a switch may be door mounted 48 or floor mounted 50. If door mounted, when the door opens, the limit switch 48 contacts close to power a timing/ transmitter unit 52 located on the inside of the door 24. Alternatively, if the limit switch is floor mounted 50, upon the opening of the door, contacts close to complete a circuit 54 through the auto close circuit module 36 to a timing unit. Although not shown, a limit switch may alternatively be positioned to extend downwardly from the garage ceiling so as to be contacted (thus contact closure) by the door when the door is near its fully opened position. In any event, upon contact closure, the timing unit will begin its time out feature.

Upon timeout, and assuming the door remains open without any activity detection, a contact closure within unit 52 or perhaps panel 32 signals the door operator to close. The activity detection enables the door to remain open in the event that a person, perhaps asleep at the wheel of a running vehicle, or a small child, is inside the garage. Such an activity detector may include an audio detector 56, a thermal sensor 58, an exhaust sensor 60, or any other detectors capable of determining whether any activity is present within the garage. These detectors are preferably contained within the floor 62 of the garage and may be connected to the module 36 by lead lines (i.e. 64, 66, and 68) in order to inhibit door closure.

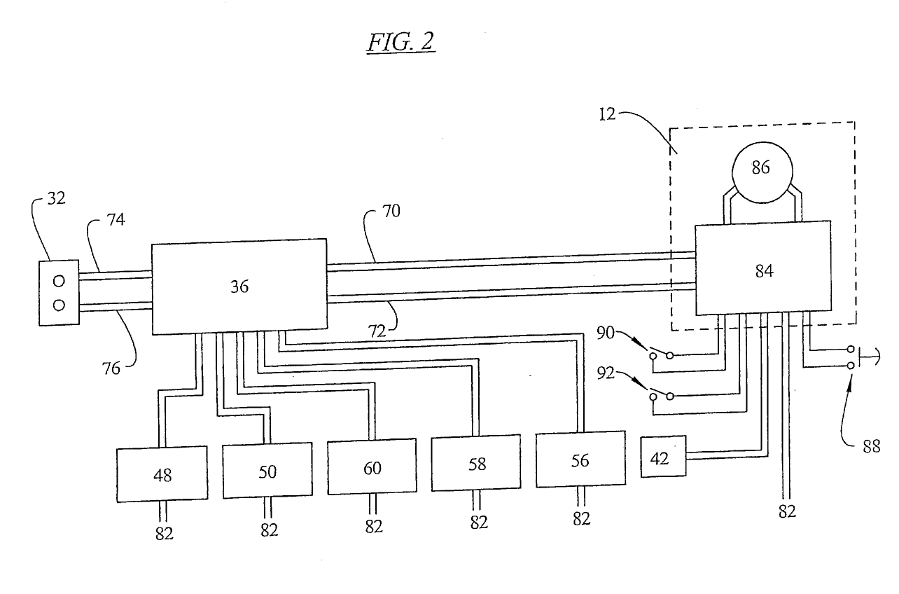

With the above general description of the principle parts of the garage door operator designed in accordance with the principles of the present invention, one can now turn to a general block diagram of the electronics thereof as illustrated in FIG. 2. More particularly, FIG. 2 illustrates the principle communication links between the sensors, the auto closure circuit module 36 and the head unit 12. The module 36 tells the head unit 12 whether or not to open 70 and/or close 72 the garage door in response to an analysis (more fully discussed below) of its various inputs. These inputs include the control panel 32 with its open 74 and close 76 switches, and the various sensor inputs. In the preferred embodiment, these sensor inputs include a door mounted 48 and/or floor mounted 50 limit switch, an audio detector 56, a thermal sensor 58 and an exhaust detector 60. Optional inputs may include multiple photocells, such as shown by the front photocell 78 and rear photocell 80 of FIG. 1. These sensors, as well as the head unit 12 are all powered via the typical 120 VAC power outlet (82).

The head unit 12 mainly consists of an operator control circuit 84 and a motor 86. The control circuit 84 analysis signals from the module 36 (70 and 72), as well as its various inputs to determine whether to direct the motor 86 to open and/or close the garage door. The inputs to the control circuit 84 in the preferred embodiment include an on/off control 88, the light sensor 42, as well as the up limit switch 90 and down limit switch 92. The head unit 12 controls the manual door operation via remote control, keypad transmitter 38 or control panel 32.

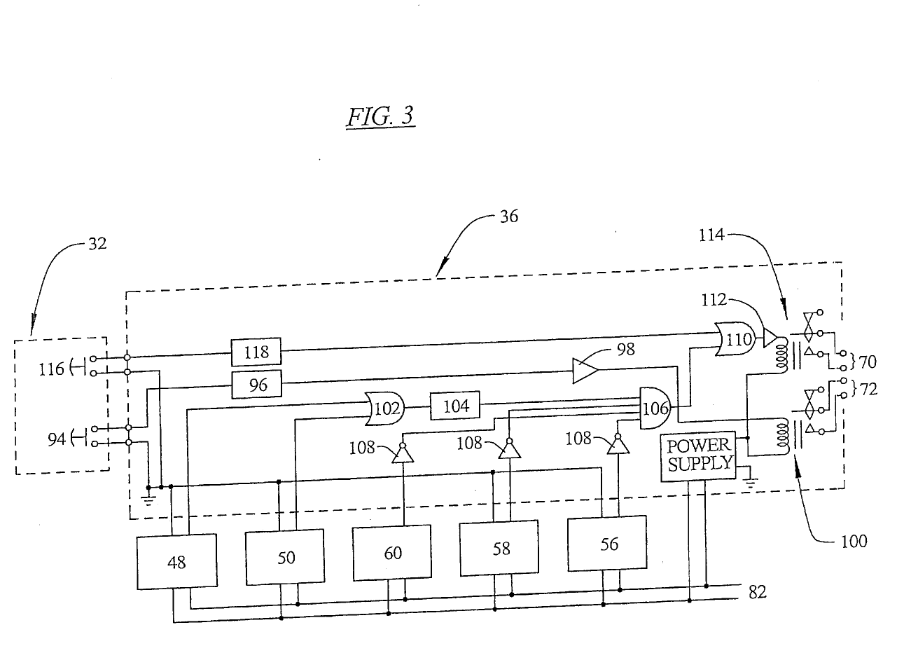

On the other hand, the automatic door operation is controlled through an analysis within the auto closure circuit module 36. This analysis consists of determining whether the door is open, if it is open then it counts down a predetermined time period, determines whether there is any activity within the garage (particularly a running vehicle) and in the absence thereof, automatically closes the door. It will be understood that the design of this module may take many forms and thus need not resemble FIG. 3 in its entirety. For example, the module need not include all three sensors (56, 58 and 60), or alternatively, may include other sensors capable of detecting activity. In any event, so long as the module can count down a predetermined time period, and automatically close the door if no activity is present, the general principles of the present invention will be achieved.

More particularly, and referring to FIG. 3, the auto closure circuit module 36 determines if and when to direct the head unit 12 to open/close the door through an internal analysis of its external inputs. These inputs include the manual door control 32 and the sensor inputs (48, 50, 56, 58 and 60). Operation of this module 36 will now be discussed through a typical example of its use.

During operation, the garage door is opened via the manual open button 94 on the door control 32, for example. This generates a signal pulse from the monostable multivibrator 96 through an amplifier 98 to the open transformer 100. The open transformer 100 in turn signals 72 the head unit 12 to open the door. When opened, the door mounted 48 or alternatively the floor mounted 50 limit switch detects same and produces a high signal into OR gate 102. Thus, if a limit switch is activated (door is opened), the timing unit or timer 104 begins its countdown. This countdown being a previously set and predetermined period of time by which the garage owner desires the door to remain open before initiating the automatic closure feature. This countdown period is initially set during the installation of the present invention, but may be adjusted at any time thereafter and/or manually shut off.

AND gate 106 continuously monitors the output of the timer 104 and the output of the inverted and amplified, by virtue of inverting amplifiers 108, signals from the audio 56, thermal 58 and/or exhaust sensors 60. Because the signals from these sensors are inverted, if the sensors DO NOT activate, their output signal will be inverted to high. When the output from the timer 104 is high and all of the outputs from the sensors (56, 58, 60) are inverted to high (not detecting any activity) the output signal of AND gate 106 is therefore high. In other words, when there is no vehicle activity detected in the garage and the timer 104 has timed out, AND gate 106 signals through OR gate 110 and amplifier 112 to the close transformer 114. The close transformer 114 in turn signals to the head unit 12 to close the door.

Alternatively, the automatic door closure operation may be manually bypassed by pressing the door close button 116 on the control panel 32. This generates a signal pulse from the monostable multivibrator 118 to OR gate 110. The output signal from gate 110 is then passed through amplifier 112 to the close transformer 114. The close transformer 114 in turn signals 70 the head unit 12 to close the door.

Additionally, this automatic closure and time-out feature may be manually shut off at any time. The shut-off button may be located, for example, on the control panel 32 next to the door open/close button 94, 116. This is useful if it is desired to keep the door open or to disable the unit. This button may be provided in conjunction with a key-lock switch in order to child-proof the unit. If the button is activated, then the door will remain open until the open/close buttons are depressed either on the control panel 32, keypad 38 or the remote. If the open/close buttons are activated, then the door is closed and the process will continuously check (loop through) to see if the shut-off button has been deactivated or the open/close buttons have been activated.

Although not shown in FIG. 3, when the timer 104 reaches “0”, i.e. its predetermined “remain open period”, both a visual alarm and an audio alarm are activated for a predetermined period of time to warn of the impending door closure. During this time of impending closure, the activity sensors (56, 58 and 60) continue to check for activity within the garage. If no activity is detected, the door is closed. However, upon the detection of activity during the impending door closure phase, the process reverts back to reset the timer 104.

Although it will be understood that the activity detectors of the present invention shall not be limited hereto, a preferred embodiment consists of an active vehicle detector. Such car detector methods may include audio detection, thermal sensing, inductive pickup and a carbon monoxide detector perhaps in the general form of a typical electrochemical carbon monoxide detector.

The audio detection circuit 56, for example, of the preferred embodiment is primarily designed to detect the sound of the running motor of an automobile. It consists of a microphone, a low and a high frequency cut-off filter, an attenuation block, along with an amplifier and level detector. The filter is tuned to pass the low frequencies typical of an automotive engine. The gain is factory set, but user adjustable to limit false tripping by extraneous noise. More particularly, the preferred embodiment includes a 3 pole low pass and a 4 pole high pass filter to provide a voltage gain roll off of 80 dB per decade below the 3 dB cut off frequency and 60 dB per decade above the 6 dB high cut off frequency. The cut off frequencies are selected to limit false sensing of sounds from heaters, ventilating fans, or other sources from blocking the desired door closing cycle.

With the preceding description of the structure and electronics of a preferred embodiment of the present invention, the following description of the operation thereof is facilitated. Initially, with the garage door 24 closed, the mounted limit switch prevents the timer from activating. When the door 24 is opened, the limit switch contacts close to activate the timer. The unit is thus activated by contact closure which starts an adjustable time delay typically between one to five minutes. If the door remains open after timeout, both audible and visual alarms are activated. The audible alarm producing a loud beeping sound while the alarm light flashes. Both cycle at a one-second ON and one-second OFF rate to warn of the impending door closure. This continues for a pre-determined time of typically between five to sixty second intervals.

Once the time interval is completed and assuming the door remains open without any activity detected, a contact closure signals the garage door operator to close. While the door is closing, a continuous tone and steady light is used as a warning to stay clear of the door. This is maintained for a period of time unto which the door is closed. If the door fails to close, the cycle repeats for a predetermined maximum number of attempts or until the door closes.

During the closing cycle, the audible and visual alarms are disabled to prevent false tripping by their activity. Once the door is closed, the door limit switch disables the circuit. No further action takes place until the door is opened again.

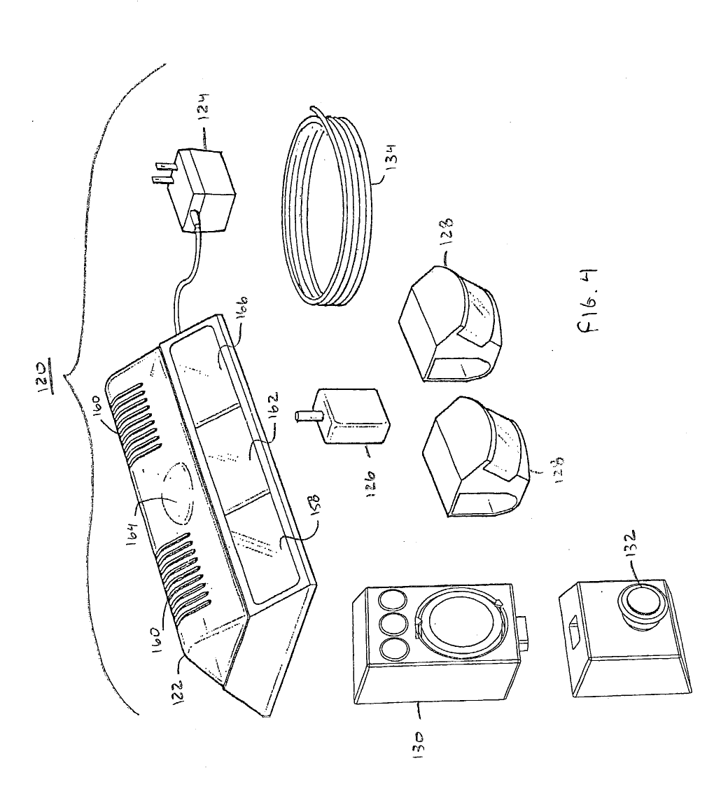

An alternate preferred embodiment of the present invention will now be described with respect to FIGS. 4-9. These Figures will illustrate a retrofit safety system which may be incorporated with any conventional garage door operating system and/or in combination with certain aspects of the safety garage door closer previously described and illustrated in FIGS. 1-3.

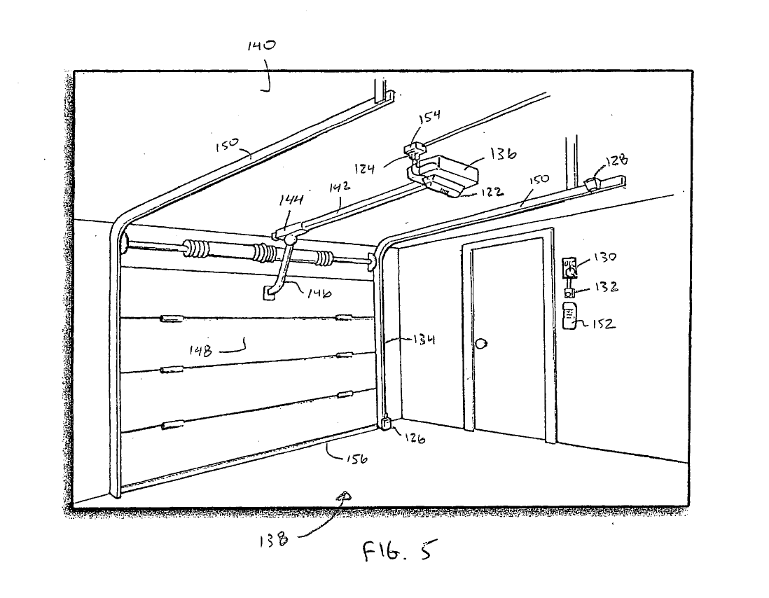

Referring particularly to FIG. 4, the preferable component parts of the retrofit safety system 120 are shown here individually. These components include a safety light panel or retrofit control unit 122 and associated power supply 124, a limit switch 126, activity detectors 128, a timer 130, a deactivation button 132 and connecting wire 134. These components are shown coupled to a conventional garage door operating system in FIG. 5. This conventional system includes a control or head unit 136 mounted within a garage 138 on a ceiling 140. A transmission including a T-rail or screw drive 142 extends from the control head 136 and has a disconnectable trolley 144 connected thereto. An arm 146 is connected to the trolley 144 and is connected to a multi-panel garage door 148 for the opening and closing thereof. The door 148 is carried on a pair of L-shaped channels 150 that is conventional for multi-panel garage doors. A radio transmitter or “remote” (not shown) may communicate by radio frequency energy to cause the head unit 136 to open and close the garage door. Likewise, an inside control panel 152 may communicate over a wire (not shown) to the head unit 136 to command it to open and close the door.

Coupled to this conventional system is the preferred retrofit embodiment 120 of the invention. In particular, the safety light panel or control unit 122 is attached to the head unit and power is provided by its power supply 124 via a typical VAC power outlet 154. Limit switch 126 is actuably coupled to preferably the bottom 156 of the garage door 148 and is in communication with the safety light panel 122. A system deactivation button 132, or manual shut-off, may be located near the control panel. An optional timer 130, may be coupled to, and be capable of, overriding the manual cut-off or deactivation button 132, thereby allowing the user to set the time of day he wants the safety closer to being working.

The retrofitting system begins to operate upon the opening of the garage door 148 either by the remote device or the service door button on the inside control panel 152. The opening of the door 148 trips the limit switch 126 which starts the systems operations controlled through the microprocessor within the safety light panel 122. This panel 122 includes a number of warning lights/indicators in the form of LEDs and when idle (door closed) preferably lights the green 158 LED. Once interrupted, by the tripping of the limit switch 126, the microprocessor goes through its pre-programmed sequence. Although this sequence is pre-programmed, the microprocessor is fully capable of allowing the user to reprogram its audible, visual and timing parameters.

In any event, the programable sequence or timing routine is preferably broken down into phases. Phase 1 lasts for 30 seconds wherein the panel emits a slow audible tone or “beep” through its speaker 160 while the green 158 LED remains on. Phase 2 lasts 20 seconds wherein the green 158 LED turns off, the yellow 162 LED turns on, the tone rate is faster and the motion detector(s) 128 and sound detector 164 are activated. Phase 3 (assuming no motion and/or sound is detected) lasts 10 seconds wherein the yellow 162 LED turns off, the red 166 LED flashes and the tone rate (beep) is fast. Phase 4 (assuming no detection) lasts 10 seconds wherein the red 166 LED remains constant and the tone rate also turns constant. Finally, Phase 5 signals a relay switch to close and the head unit to deactivate the detector(s) 128 and close the door 148. In the event the detectors are active and detect, the microprocessor returns the system to Phase 1.

During Phase 5, microprocessor allows 20 seconds for the limit switch 126 to signal to it that the door 148 as been closed. If the limit switch does not give the door closed signal, the system will automatically run a 10 second safety check which activates the sensors. If the sensors are not alarmed, the system will try another attempt at closing the door. This process may repeat for preferably four cycles. After the fourth cycle, if the switch still has not given the door closed signal, the system will turn off all sensors and the system alarm light will stay lit. Although the above phases may seem rather distinct, it will be understood that these phases can be altered and/or additional phases may be added and/or phases may be cycled differently.

Along with the flexibility to be able to program the phases, the retrofit system provides the ability to manually shut the process off by the deactivation button 132 thereby going back to the conventional (before retrofitted) garage door system. Additionally, the user has the option to set the time of day for using and/or not using the retrofit safety system by programming his desired on and/or off times via timer 130.

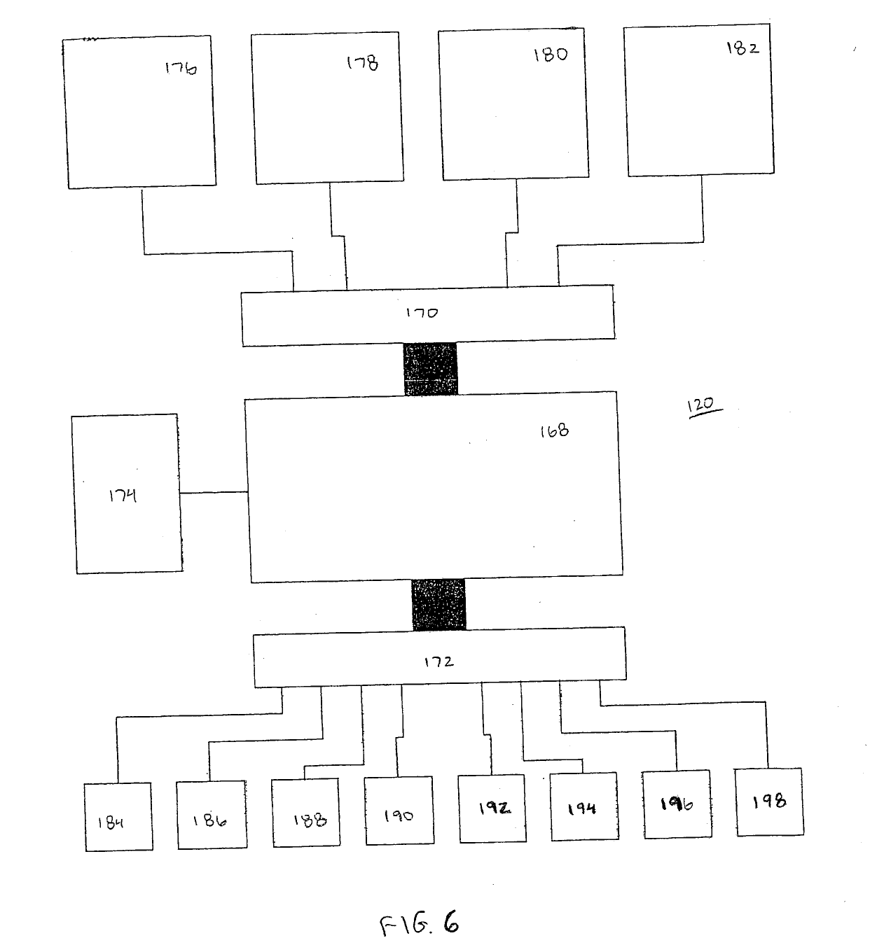

The brains of the retrofit safety system 120 is the microprocessor. FIG. 6 illustrates the inter-connectivity of the system vis-a-vis the microprocessor 168. The three main microprocessor connections are its inputs 170, its outputs 172 and the manual deactivation 174 connection. The main inputs include sound detection 176, motion detection 178, door contact 180 and the time selection switch 182. The main outputs include door switch activation 184, red lamp 186, yellow lamp 188, green lamp 190, red LED 192, green LED 194, green LED2 196 and alarm sound buzzer 198.

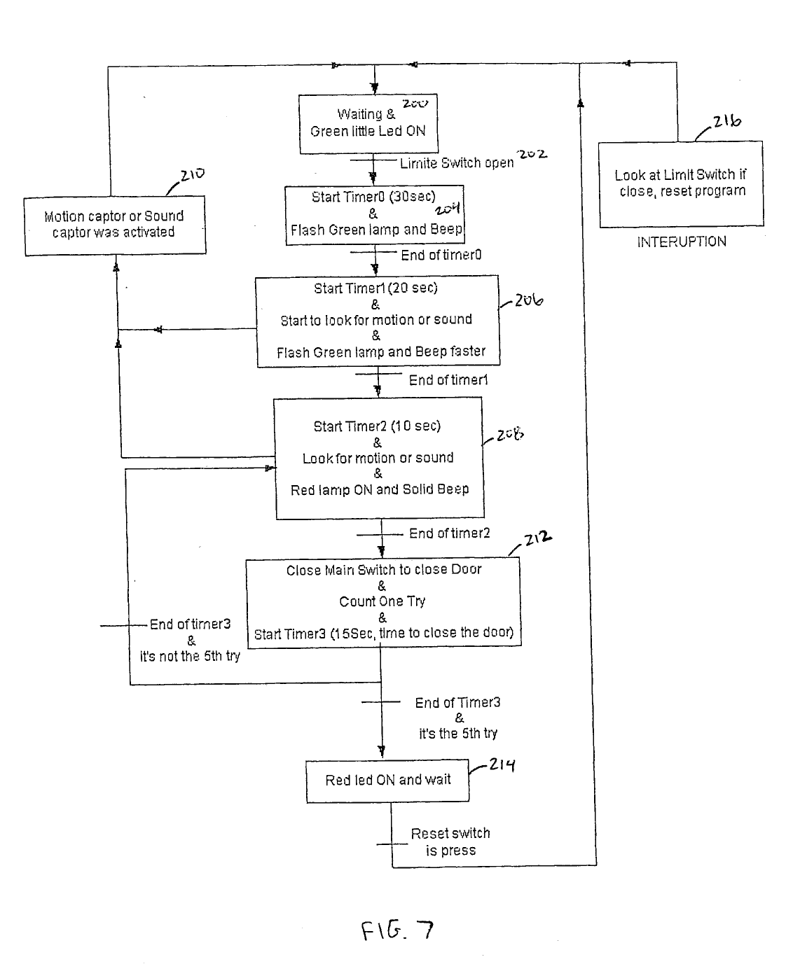

The logic of the microprocessor is illustrated by FIG. 7. For illustration purposes and by way of another example, phases of the retrofit safety system are described therein and as follows. The start position 200 has the door closed and waiting with the green little LED on. The limit switch is opened 202, internal timer has started with a green lamp flash and beep 204. The timer now starts to look for motion or sound, the green lamp flashes and the beep is faster at 206. At block 208 the detectors are still looking for motion or sound, the red lamp is on and the beep is now a solid tone. If the detectors capture motion or sound 210 at blocks 206 or 208, the system goes back to start at 200. At block 212, the system has not detected anything and now starts the automatic door closure process. If the door does not close within a certain amount of time (i.e. 15 seconds), the system goes back to block 208. If the door still does not close after preferably five attempts from block 212, the red LED stays lit and the systems waits at block 214 until the program is reset at block 216.

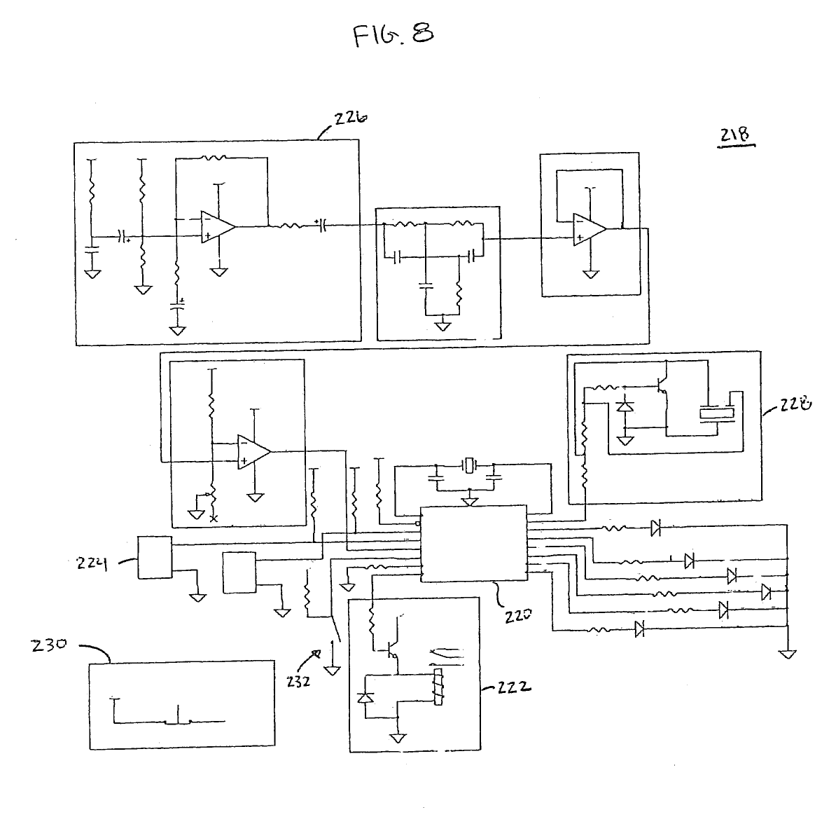

The logic of the microprocessor is also illustrated by FIG. 8 wherein a general circuit diagram of the system is shown. It will be understood that the design of the circuit may take many forms and need not resemble FIG. 8 in its entirety, so long as the system works as intended. In any event, the particular design of the circuit of FIG. 8 includes a microprocessing chip 220 at its center and its related surrounding circuitry. This related circuitry includes, among other things, the door switch system activation 222, an infrared detector 224, a sound detector 226, an alarm sound emitter 228, the deactivation button 230 and the time of day selection switch 232.

Irrespective of the exact components/wiring of the retro fit safety system 120, it nevertheless provides a benefit to conventional garage systems. The ability to automatically close an opened garage door after a predetermine time interval, with the added sound and motion safety detectors, provides one with a secure garage environment to protect from theft. It also increases home and family safety on those homes with attached garage units. The sensor system provides a safer door closing environment than currently available in the industry. Finally, it is compatible with any automatic garage door system that has electric safety beams and is easy to install.

While particular embodiments of the invention have been shown and described, it will be obvious to those skilled in the art that changes and modifications may be made therein without departing from the invention in its broader aspects and, therefore, the aim in the appended claims is to cover all such changes and modifications as fall within the true spirit and scope of the invention.

1. A retrofit automatic garage door closer to be used with existing door operators having a motor and a transmission connecting the motor to the door to open and close the door, the automatic closer comprising:
a control unit connected to the motor and capable of commanding the motor to open and close the door;
said control unit including a timing routine for timing a period in which the door is in an opened position, said unit capable of actuating the motor to close the door after said period has timed out; and
at least one detector for detecting whether there is activity within the garage, said detector in communication with said control unit whereby the detection of activity alters said timing routine.

2. A retrofit automatic garage door closer as defined in claim 1 further including a means for initiating said timing routine.

3. A retrofit automatic garage door closer as defined in claim 2 wherein said means for initiating said timing routine is a limit switch.

4. A retrofit automatic garage door closer as defined in claim 2 further including a means for determining whether the timing routine has properly completed.

5. A retrofit automatic garage door closer as defined in claim 4 wherein said means for determining is a limit switch.

6. A retrofit automatic garage door closer as defined in claim 1 further including a manual shut-off for disabling the automatic door closer.

7. A retrofit automatic garage door closer as defined in claim 1 further including a programmable timer for setting a desired time of day whereby said automatic closer will be functioning.

8. A retrofit automatic garage door closer as defined in claim 1 wherein said control unit is further capable of indicating different phases of said timing routine.

9. A retrofit automatic garage door closer as defined in claim 8 wherein said unit includes a visual and/or audible indication of a phase.

10. A retrofit automatic garage door closer as defined in claim 1 wherein said timing routine is programmable.
